(19) United States
(12) Patent Application Publication
(10) Pub. No.: US 2014/0081837 A1
(43) Pub. Date: Mar. 20, 2014

(54) PAYMENT TRANSACTION GATEWAY FOR A MEDIA PLAYER

(71) Applicants: Mark Rybarczyk, Kennett Square, PA (US); Brick Rucker, Playa Del Ray, CA (US)

(72) Inventors: Mark Rybarczyk, Kennett Square, PA (US); Brick Rucker, Playa Del Ray, CA (US)

(73) Assignee: VUIER, INC., Kennett Square, PA (US)

(21) Appl. No.: 13/617,830

(22) Filed: Sep. 14, 2012

(51) Int. Cl. G06Q 30/06

(52) U.S. Cl. 705/39

(57) ABSTRACT

A method and apparatus for a payment transaction gateway in a media player are disclosed. Content provided to the media player is sectored into a preview portion and a pay gate portion. The preview portion may be provided free of charge, whereas a user is required to pay a fee or accept a charge to receive the pay gate portion of the content. A payment transaction gateway that is initiated in the media player is used to facilitate the payment of the fee or the acceptance of the charge. The payment transaction gateway allows a user to log in to an account, register for an account, or guest-pay for the content within the confines of the media player and without running another application. Further, a content provider is also enabled to price content based on a minimum price associated with the content.

### BACKGROUND

Internet users have the ability to purchase multimedia content, such as movies, television shows, and songs, and stream the multimedia content for playing on their Internet-connected devices, such as computers, tablets, phones, and smart televisions, for example. To purchase the content, Internet users are required to use a software application for an Internet store or market, and to play the content, the Internet users are required to use a multimedia player. This two-step process for purchasing content requires Internet-connected devices of the users to be loaded with extraneous applications and also results in a poor user experience.

Additionally, before purchasing the content the Internet users are not provided with a good mechanism for sampling the content. Invariably, Internet stores and markets offer trailer-like snippets of the content that are primarily intended to entice the users to buy the content rather than to offer an honest preview of the content.

It is, therefore, desirable to have a method and apparatus for a payment transaction gateway for a media player that facilitates the purchase of content within the media player. It is also desirable to have a method and apparatus for providing samples of the content to Internet users.

### SUMMARY

A method and apparatus for streaming content from a content server to a client terminal are provided. In the method and apparatus, the content includes a preview portion and a pay gate portion. The content server provides the preview portion of the content to the client terminal. In an embodiment, a payment transaction gateway is initiated. The payment transaction gateway requesta an acceptance of a fee associated with the pay gate portion of the content at the client terminal. In another embodiment, a payment server receives an indication of the acceptance of the fee at the client terminal. In yet another embodiment the content server provides to the client terminal the pay gate portion of the content.

In some embodiments, the payment transaction gateway requests a user to log in to an account with the payment server. Further, the content may be played by a media player. In other embodiments, the payment transaction gateway may be within the media player and the media player may be an in-browser media player and may be capable of being imbedded in any website. A length of the preview portion, a beginning of the preview portion, an end of the preview portion, a length of the pay gate portion, a beginning of the pay gate portion, or an end of the pay gate portion may be determined by a content provider.

### BRIEF DESCRIPTION OF THE DRAWINGS

A more detailed understanding may be had from the following description, given by way of example in conjunction with the accompanying drawings wherein:

FIG. 1 shows a client terminal in communication with a content server and a payment server over a network;

FIG. 2 shows a flow diagram of a method for using a payment transaction gateway;

FIG. 3 shows a display for a client terminal having an in-media player payment transaction gateway;

FIG. 4 shows a display for a client terminal having an in-media player payment transaction gateway;

FIG. 5 shows a flow diagram of a method for receiving content employing a payment transaction gateway; and

FIG. 6 shows a content creator terminal in communication with a processing server, a content server, and a payment server.

### DETAILED DESCRIPTION

A client terminal, such as a computer, a tablet, a smart phone, a smart television, or a streaming player may be equipped with network connectivity and may, thereby, be permitted to connect to networks such as a local network or the Internet. Using the network connectivity the client terminal may receive content via streaming from a content server. The content may be any media, such as audio, video, text, or multimedia and the client terminal may play the content using any media player. Further, the client terminal may be equipped with a display, speaker, or other input/output device to facilitate playing the content to a user.

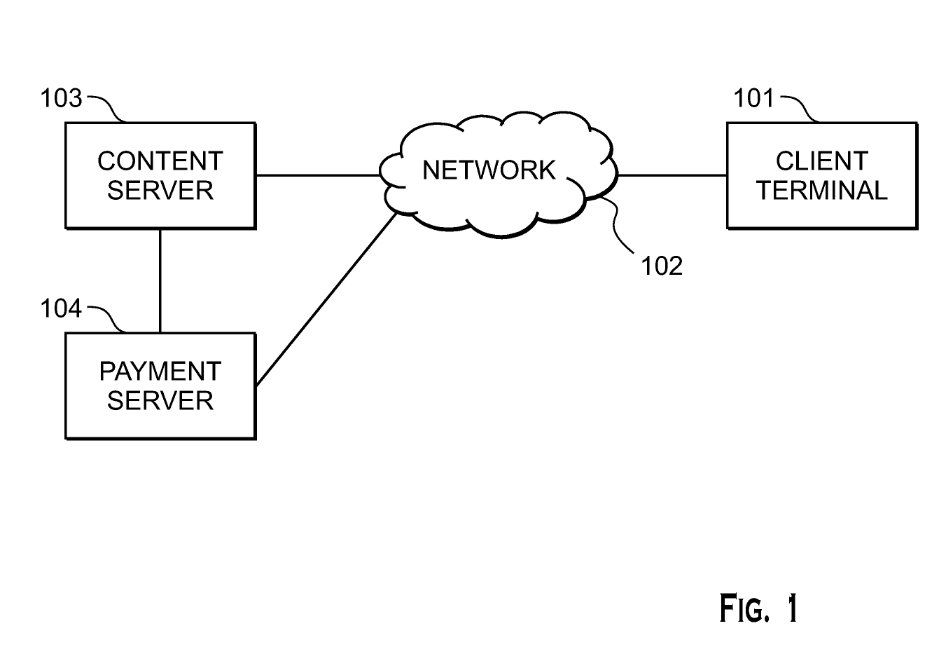

Content may be available for streaming free of charge and thereby a user may not incur a monetary expense in receiving the content at a client terminal or playing the content. Conversely, some content that is available for streaming may be said to be behind a pay gate, and as such, a user is required to pay a monetary fee or accept a charge in order receive the content at the client terminal. Thus, in addition to being connected to a content server, a client terminal may also be connected to a payment server for enabling a user of the client terminal to pay a fee for content that is behind a pay gate as described with reference to FIG. 1.

FIG. 1 shows a client terminal in communication with a content server and a payment server over a network. The client terminal 101 is connected via the network 102 to the content server 103 and the payment server 104. The client terminal 101 may be any device that is equipped with content streaming or computing capability. The network may be a local network, an intranet, the Internet, or an Internet service provider (ISP) network. Further, the content streaming or computing capability of the client terminal 101 may be local to the client terminal 101 or network-based (i.e. cloud-based).

The content server 103 may be capable of providing content or routing content to the client terminal 101. Additionally, the content server 103 may utilize a streaming mechanism to provide the content to the client terminal 101.

The payment server 104 is in communication with the content server 103. The payment server 104 may be capable of processing a payment that is made by a user in order for the client terminal 101 to receive paid-for content. The payment server 104 may receive the payment from the client terminal 101 and may authenticate the payment. Upon authentication of the payment, the payment server 104 may authorize the content server 103 to stream the content to the client terminal 101.

The client terminal 101 may be equipped with a media player that enables the client terminal 101 to play received content. The media player may be a standalone player, such as Zune™ or iTunes™, or an embedded player, such as a browser-embedded player. Examples of a browser-embedded player include Adobe Flash™, Hypertext Mark-up Language 5 (HTML5). The media player may decode received content according to any coding scheme such as Moving Picture Experts Group (MPEG) 2 (MPEG-2), or MPEG-4, also known as International Telecommunications Union (ITU) Telecommunication Standardization Sector (ITU-T) H.264. Further, the media player may process any kind of file format, such as, Adobe Flash™ F4V or FLV, or any International Organization for Standardization (ISO) base media file format, and may be compliant with any streaming protocol, such as MPEG Dynamic Adaptive Streaming over Hypertext Transfer Protocol (HTTP) (MPEG-DASH), or HTTP Live Streaming (HLS). Additionally, a browser-embedded player may operate in conjunction with any web technology, such as HTML5.

In an embodiment, a portion of the content may be available free of charge whereas the remainder of the content may be behind a pay gate. Further, content may be sectored into two portions; a first portion being a preview portion and a second portion being a pay gate portion. The client terminal 101 may be allowed to receive the preview portion of the content free of charge, but a user may be required to pay a monetary fee or may be triggered or prompted to provide a payment or accept a charge in order for the client terminal 101 to receive the pay gate portion of the content. Accordingly, a user of the client terminal 101 may sample the content based on the preview portion and then decide whether to pay for the pay gate portion.

In one embodiment, the preview portion may temporally precede the pay gate portion of the content. For example, if the content is a five-minute video clip, then the preview portion may be the first twenty seconds of the video clip and the pay gate portion may be the remaining four minutes and forty seconds of the video clip.

In another embodiment, the entirety of content may be behind a pay gate, and, therefore, a user may be required pay a fee in order for the entirety of the content to be streamed to the client terminal 101. For example, if the content is an episode of television show and if the entire episode is behind a pay gate, the user may be required to pay a fee for the entire episode.

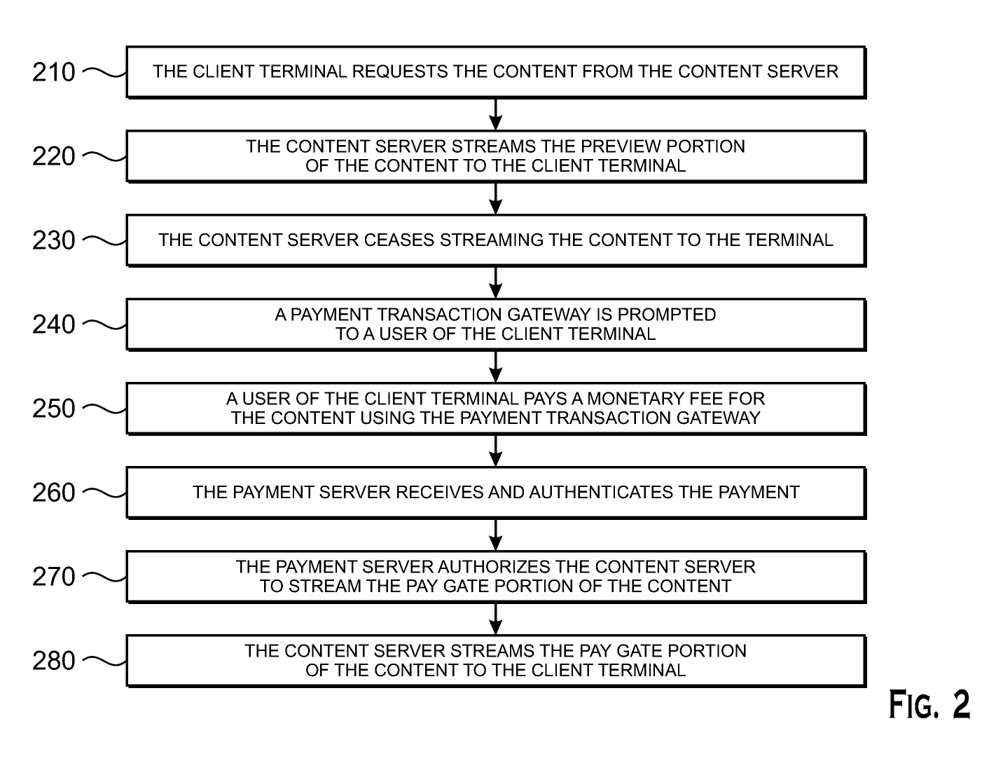

A payment transaction gateway may be used for enabling a user to provide a payment or accept a charge in order for the client terminal 101 to receive or play the pay gate portion as described with reference to FIG. 2.

FIG. 2 shows a method for using a payment transaction gateway. In the method 200, the client terminal 101 requests the content from the content server 103 210. Upon receiving the request, the content server 103 streams the preview portion of the content to the client terminal 101 220. When the preview portion ends, the content server 103 ceases streaming the content to the client terminal 101 230. Then, a payment transaction gateway is prompted to a user of the client terminal 101 240. A user of the client terminal 101 pays a monetary fee for the content using the payment transaction gateway 250. The payment server 104 receives and authenticates the payment 260 and authorizes the content server 103 to stream the pay gate portion of the content 270. Then, the content server 103 streams the pay gate portion of the content to the client terminal 101 280.

To pay the fee for receiving the pay gate portion of the content, the user may be requested to provide payment information to the payment server 104 via the payment transaction gateway. For example, the user may be asked to provide credit card information, bank account information, or account information for a third party on-line payment system, such as Paypal™ or Dwolla™, for example, to which the fee may be applied. It is noted that the fee may be in any monetary denomination and may be on a micropayment level, such as one cent.

Further, the user may have an account with the payment server 104 or with a service associated with the payment server 104. The account may be funded with monetary payments or the account may hold payment information for the user (such as, credit card, bank account, or on-line payment system information). The payment transaction gateway may require a user to log into their account in order to pay a fee for receiving the pay gate portion of the content. The payment server 104 may keep track of the user's account balance with the payment server 104 and any credit or debt transactions made on the account. Further, the user may have access to the user's account balance and transactions.

The payment transaction gateway may be an independent application or an independent software program of the media player used to play the content. As an independent application, the payment transaction gateway may be triggered or initiated in the user terminal for the user to pay the fee for receiving the pay gate portion of the content.

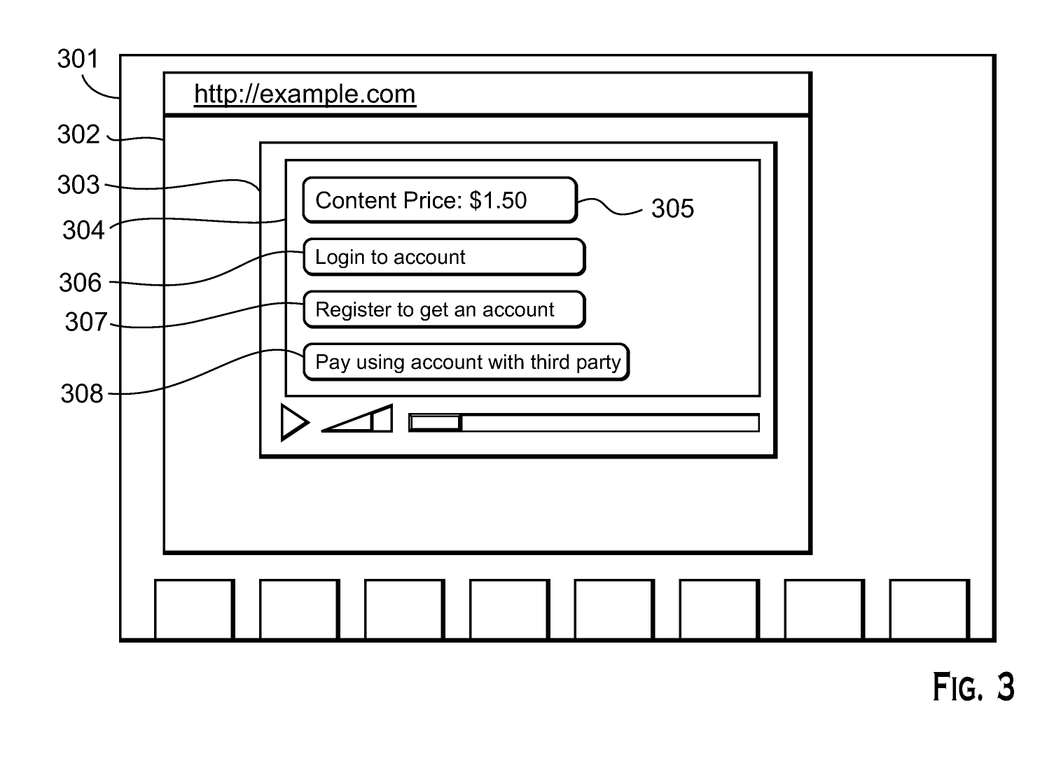

Alternatively, the payment transaction gateway may be in-media player, as described with reference to FIG. 3.

FIG. 3 shows a display for a client terminal 101 having an in-media player payment transaction gateway. The display 301 may be a display for any client terminal 101, such as client terminal 101 described with reference to FIG. 1. The display 301 shows a browser application 302 having an in-browser media player 303. The in-browser media player 303 may be utilized to play both the preview portion and the pay gate portion of content. It is noted that the in-browser media player 303 may be in a website of a content distributor, such as vuier.com or youtube.com, or may be embedded on another website, such as a blog, a social networking website, or a news aggregation website.

As described herein, prior to receiving the pay gate portion of the content, a payment transaction gateway 304 is initiated in the media player 303. The payment transaction gateway 304 displays the fee amount 305 required to receive the pay gate portion of the content. The payment transaction gateway 304 provides an option for the user to log in to the user's account 306 with the payment server 104 in order to pay the fee for receiving the pay gate portion of the content. The payment transaction gateway 304 also provides an option for the user to register to get an account 307 with the payment server 104 and pay using a third party account 308. Although not shown in FIG. 3, the payment transaction gateway 304 may also offer the user a guest payment option, whereby the user may pay for the pay gate portion of the content directly and without using an account with the payment server 104 or a third party. Furthermore, the payment transaction gateway 304 may offer links to information intended to help the user navigate the payment transaction gateway 304.

If the user selects to log in to the user's account with the payment server 104, the payment transaction gateway 304 enables the user to log in to their account with the payment server 104 by providing the user with the option to enter their user name and password for the account. Similarly, the payment transaction gateway 304 enables the user to log in to their account with the third party by providing the user with the option to enter their user name and password for their account with the third party. Further, in the event that the user does not have an account with the payment server 104, the payment transaction gateway 304 enables a user to create an account with the payment server 104.

The user may log in to an account or register for an account using the payment transaction gateway 304 and without using another application. The payment transaction gateway 304 may provide the user's log in information or registration information to the payment server 104 or the third party.

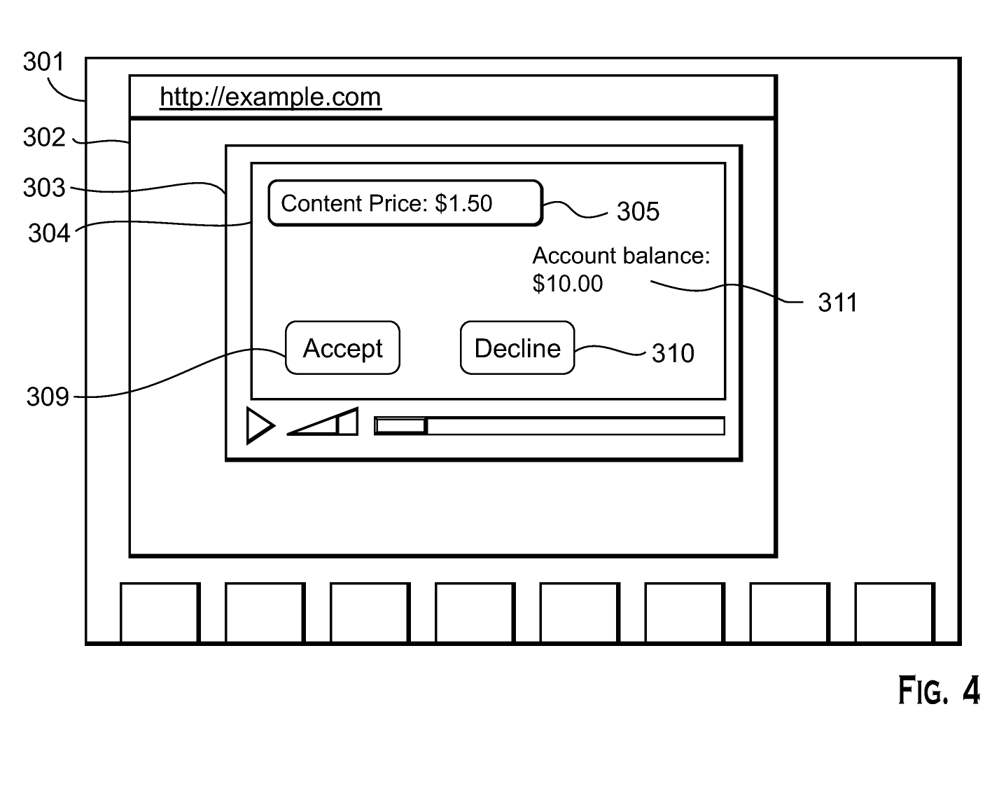

After the user provides their log in information and after the verification of the log in information, the payment transaction gateway 304 may request the user to accept a charge in order to receive the pay gate portion of the content as described with reference to FIG. 4.

FIG. 4 shows a display for a client terminal 101 having an in-media player payment transaction gateway 304. The display 301 shows a browser 302 with an in-browser media player 303. Further, the in-browser media player 303 shows a payment transaction gateway 304. The payment transaction gateway 304 displays the fee amount 305 required to receive the pay gate portion of the content. The payment transaction gateway 304 also provides the user with options to accept the fee 309 or decline the fee 310 and the user may select either option. The payment transaction gateway 304 also displays the balance 311 of the user's account with the payment server 104 or the third party.

If the user accepts the fee, then the cost of the content is charged to the user's account with the payment server 104 or to the user's account with the third party and the user terminal may then receive the pay gate portion of the content. Conversely, if the user declines the fee, then the user terminal may not receive the pay gate portion of the content and the user may seek other content.

When displayed, the payment transaction gateway 304 may appear as an overlay on top of played content in the media player 303. For example, when the payment transaction gateway 304 is initiated, the media player 303 may display the last frame of the preview portion of the content and overlay the last frame of the preview portion with the payment transaction gateway 304. Alternatively, the media player 303 may overlay the payment transaction gateway 304 with a blank frame, such as a black frame or a white frame.

The payment transaction gateway 304 may be implemented using an application programming interface (API) associated with the media player 303. For example, if the media player 303 is an Adobe Flash or an Adobe Air media player, an API of Adobe Flash or an Adobe Air may be utilized for implementing the payment transaction gateway 304. Further, HTML5 may also be used for implementing the media player and the payment transaction gateway 304. In an embodiment, on a condition that the media player supports HTML5 then HTML5 is used, and on a condition that the media player does not support HTML5 then Adobe Flash is used.

As described herein, the payment transaction gateway 304 may be entirely within the confines of the media player 303 and the user may not be required to navigate away form the media player 303 to log in to an account or accept a fee for receiving content.

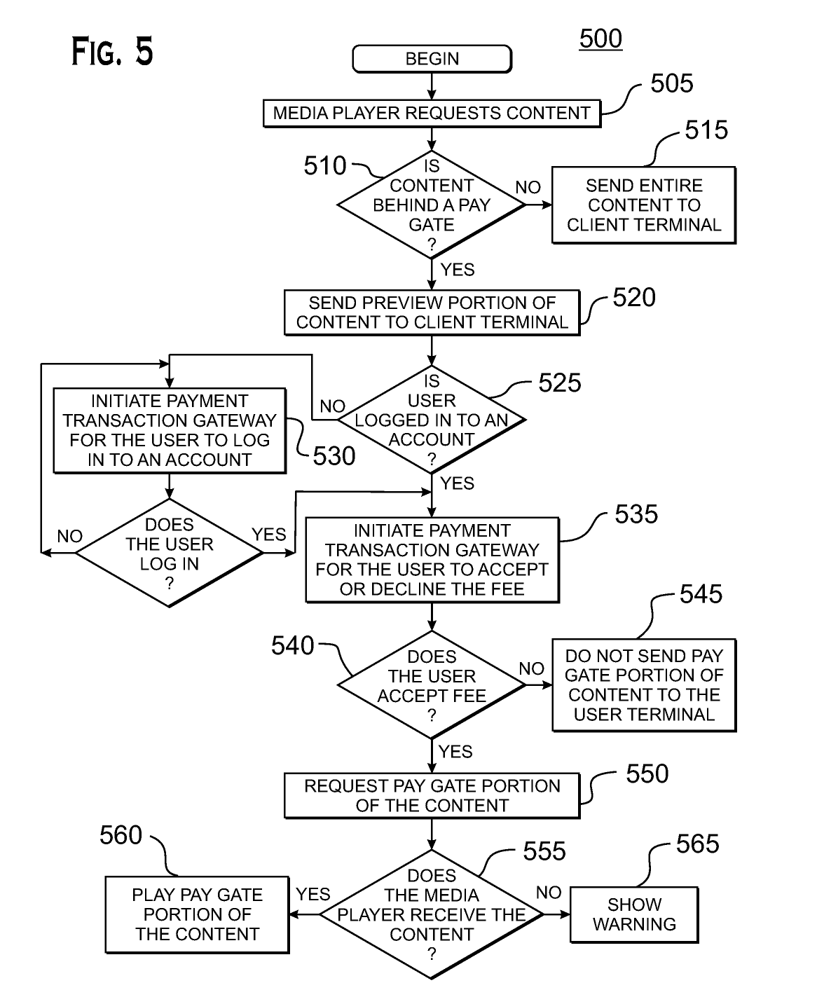

FIG. 5 shows a flow diagram of a method for receiving content employing a payment transaction gateway 304. In the method 500, a media player requests content 505, for example, based on a content identity. A determination is then made as to whether the content is behind pay gate 510. If it is determined that the content is not behind a pay gate then the entire content, including, for example, advertisements, is sent to the client terminal 101 515.

If it is determined that the content is behind a pay gate then the preview portion of the content is sent to the client terminal 101 520. Then it is determined whether the user is logged in to an account with the payment server 104 or an account with a third party 525. If it is determined that the user is neither logged in to an account with the payment server 104 or an account with a third party, then a payment transaction gateway 304 is initiated in the media player providing an option for the user to log in to the user's account with the payment server 104 or pay using a third party account 530. If the user does not log in, then the payment transaction gateway 304 is initiated again 530.

If the user logs in using the payment transaction gateway 304 or if it is determined, at 525, that the user is either logged in to an account with the payment server 104 or an account with a third party, then a payment transaction gateway 304 is initiated providing an option for the user to accept the fee or decline the fee 535 associated with receiving the pay gate portion of the content.

It is then determined whether the fee is accepted by the user 540. If the user declines the fee, then the pay gate portion is not sent to the user terminal 101 545. If the user accepts the fee, then the media player or payment transaction gateway 304 requests the pay gate portion of the content based the user's acceptance of the fee 550.

If the media player receives the pay gate portion of the content 555 then the media player plays the pay gate portion 560. If the media player does not receive the pay gate portion of the content 555 then a warning is shown 565, such as an insufficient account balance warning.

In one embodiment, content creators may upload their content to the content server 103 in order to allow users to receive or stream the content and in order to solicit audience or viewership for content. Furthermore, when the content is placed behind a pay gate, the content creators may generate profits based on the fees that users pay to receive the content.

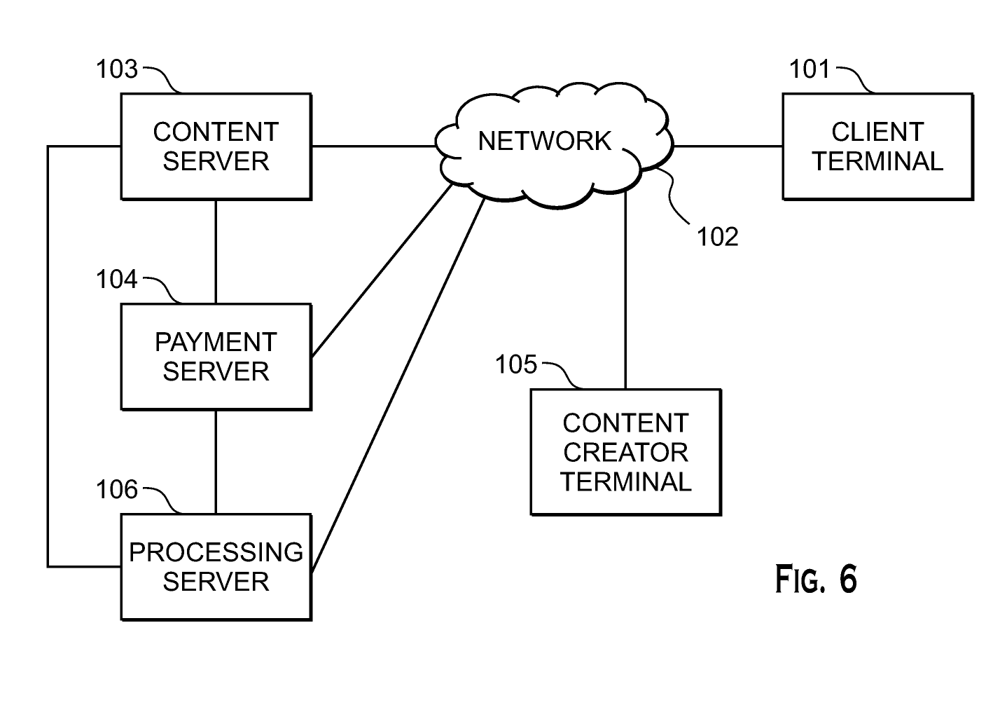

The profits generated by content creators may be dependent upon storage costs incurred in placing the content on the content server 103, streaming costs incurred in delivering the content to client terminals (such as client terminal 101 of FIG. 1), and administrative and miscellaneous costs. Content creators may set the price of their content to account for the costs. To assist content creators in setting appropriate pricing, a processing server may be utilized as described with reference to FIG. 6.

FIG. 6 shows a content creator terminal in communication with a processing server, a content server 103, and a payment server 104. A content creator may use the content creator terminal 105 to place content on the content server 103. When placing the content on the content server 103, a processing server 106 may assist the content creator setting a price of the content.

The processing server 106 may also allow the content creator to set the length or the boundaries of the preview portion and the pay gate portion of the content. For example, a short preview portion may be used for low-priced content, whereas a longer preview portion may be used for higher-priced content. The content creator may set a beginning of a preview portion of the content, an end of the preview portion of the content, a beginning of a pay gate portion of the content, or an end of the pay gate portion of the content.

To assist the content creator in setting a price for the content, the processing server 106 may determine or estimate the storage, streaming, and administrative and miscellaneous costs associated with the content. The storage, streaming, and administrative and miscellaneous costs may be based on the size of the content as a computer file or the length of the content as audio, video, media, or any multimedia. For example, the costs may be set to a predetermined monetary amount per megabyte (MB) of the content as a computer file, or a predetermined monetary amount per minute of media.

The processing server 106 may also determine a minimum price associated with the content. The minimum price may be set based on the determined costs. The content creator may set the price of the content to be equal to or higher than the minimum price. The difference between the price of the content set by the content creator and the minimum price represents the profit a content creator makes each time a user pays for the content. The minimum price, on the other hand, may be credited to an operator of the content server 103, payment server 104, or processing server 106. The minimum price may be used by the operator to offset the costs incurred in the storage, streaming, or distribution of the content or the maintenance of the content server 103, payment server 104, or processing server 106.

The processing server 106 may also track the number of times content has been received by a stand-alone media player, or an in-browser or an embedded media player on any website. Further, the processing server 106 may track the fees paid by users to receive the content, and the profits a content creator generated. A content creator may have access to the information tracked by the processing server 106. Further, the profits a content creator generated may be credited to an account of the content creator, such as a bank account, an account with the processing server 106, or an account with the payment server 104, or a third party account.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for streaming content from a content server to a client terminal, wherein the content includes a preview portion and a pay gate portion, the method comprising:
providing, by the content server to the client terminal, the preview portion of the content;
initiating a payment transaction gateway, wherein the payment transaction gateway requests an acceptance of a fee associated with the pay gate portion of the content at the client terminal;
receiving by a payment server an indication of the acceptance of the fee at the client terminal; and
providing, by the content server to the client terminal, the pay gate portion of the content.

2. The method of claim 1, wherein the payment transaction gateway requests a user to log in to an account with the payment server.

3. The method of claim 1, wherein the content is played by a media player.

4. The method of claim 3, wherein the payment transaction gateway is within the media player.

5. The method of claim 3, wherein the media player is an in-browser media player and wherein the in-browser media player is capable of being imbedded in any website.

6. The method of claim 1, wherein a length of the preview portion, a beginning of the preview portion, an end of the preview portion, a length of the pay gate portion, a beginning of the pay gate portion, or an end of the pay gate portion is determined by a content provider.

7. A method for streaming content from a content server to a client terminal, wherein the content includes a preview portion and a pay gate portion, the method comprising:
receiving, by the client terminal from the content server, the preview portion of the content;
receiving a request for an acceptance of a fee associated with the pay gate portion of the content, wherein the request is received via a payment transaction gateway at the client terminal;
indicating the acceptance of the fee to a payment server; and
receiving, by the client terminal from the content server, the pay gate portion of the content.

8. The method of claim 7, wherein the payment transaction gateway requests a user to log in to an account with the payment server, requests a user to log in to an account with a third party, or requests a user to make a guest payment.

9. The method of claim 7, wherein the content is played by a media player.

10. The method of claim 9, wherein the payment transaction gateway is within the media player.

11. The method of claim 9 wherein the media player is a Flash media player or an Hypertext Mark-up Language 5 (HTML5) media player.

12. A method for streaming content, wherein the content includes a preview portion and a pay gate portion, the method comprising:
receiving the content by a processing server from a content creator terminal;
determining a minimum cost associated with the content based on storage and transmission costs of the content;
providing the minimum cost to the content creator terminal; and
receiving from the content creator terminal a selected cost, wherein the selected cost is greater than or equal to the minimum cost.

13. The method of claim 12, wherein the storage and transmission costs are predetermined per one minute of audiovisual media.

14. The method of claim 12, wherein the storage and transmission costs are predetermined per one megabyte (MB) of a computer file size associated with the content.

15. The method of claim 12, further comprising:
receiving from the content creator terminal an indication of a beginning of a preview portion of the content, an indication of an end of the preview portion of the content, an indication of a beginning of a pay gate portion of the content, or an indication of an end of the pay gate portion of the content.

16. The method of claim 12, further comprising:
providing, by a content server to a client terminal, the preview portion of the content;
initiating a payment transaction gateway, wherein the payment transaction gateway requests an acceptance of a fee associated with the pay gate portion of the content at the client terminal;
receiving by a payment server an indication of the acceptance of the fee at the client terminal; and
providing, by the content server to the client terminal, the pay gate portion of the content.

17. The method of claim 16, wherein the payment transaction gateway requests a user to log in to an account with the payment server, requests a user to log in to an account with a third party, or requests a user to make a guest payment.

18. The method of claim 16, wherein the content is played by a media player.

19. The method of claim 16, wherein the payment transaction gateway is within the media player.

20. The method of claim 19, wherein the media player is a Flash media player or an Hypertext Mark-up Language 5 (HTML5) media player.
